(19) United States
(12) Patent Application Publication
(10) Pub. No.: US 2006/0251271 A1
(43) Pub. Date: Nov. 9, 2006

(54) Ceiling Mounted Loudspeaker System

(76) Inventor: Anthony Grimani, Fairfax, CA (US)

Correspondence Address: STAINBROOK & STAINBROOK, LLP, 3558 ROUND BARN BLVD., SUITE 203, SANTA ROSA, CA, 95403, US

(21) Appl. No.: 11/381,722

(22) Filed: May 4, 2006

Related U.S. Application Data
(60) Provisional application No. 60/677,698, filed on May 4, 2005.

(51) Int. Cl. H04B 15/00

(52) U.S. Cl. 381/94.5

(57) ABSTRACT

A ceiling-mounted speaker system which employs directional-radiating electro-acoustic transducer arrays which aim sound waves at suitable surfaces in the room, whereby the sound is perceived as coming from a location matching a screen location. Pattern control of the sound radiation provided by signal delay within array columns and rows enhances sound clarity.

### CROSS REFERENCES TO RELATED APPLICATIONS

The present application claims the benefit of U.S. Provisional Patent Application Ser. No. 60/677,698, filed May 4, 2005, (May 4, 2005).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to hi-fidelity audio loudspeaker systems, and more particularly to a ceiling mounted loudspeaker system that eliminates the need to locate speakers in multiple positions around a room while still producing a sound field that gives the listener the impression that sound is emanating from the walls of the room.

2. Discussion of Related Art Including Information Disclosed Under 37 CFR §§1.97, 1.98

Loudspeaker systems for multichannel surround sound applications, such as home theaters, typically include five or seven “main” loudspeakers plus a low-frequency loudspeaker called a subwoofer. These main loudspeakers can be difficult to place within the living area of a residence, not only because of space constraints, but because they are unsightly and often conflict with other decorating and design elements in the room. Some home theaters owners have attempted to solve this problem by flush-mounting the loudspeakers in the room walls, thus rendering them less visible. However, this solution requires wall structures that can accommodate such an installation, and it is a labor-intensive and costly way of dealing with the problem.

Other home theater owners have located flush-mounted loudspeakers on the ceiling of the room, thereby making them virtually disappear from conscious view. This latest solution, while esthetically pleasing poses a major acoustic problem: The sound emanates from the ceiling, but it is not perceived by listeners as emanating from the same location as the picture Additionally, the sound can lack clarity as the loudspeakers are energizing the reverberant field of the upper portions of the room. Various solutions to home theater sound reproduction problems have been proposed, including the following exemplary patents.

U.S. Pat. No. 5,043,970. to Holman, discloses an early sound reproduction system adapted for use in home theaters and intended to achieve the sound characteristics of the motion picture sound listening environment. This patent teaches means to overcome spectral imbalance when playing home video versions of motion pictures by re-equalization with a correction response curve that compensates for the equalization for playback in large theater-sized auditoriums inherent in motion picture soundtracks. Improvement of surround-sound home playback of motion pictures is achieved by using main channel loudspeakers that produce direct sound fields and surround channel loudspeakers that produce diffuse sound fields. Slight pitch shifting in the signals is applied to multiple surround loudspeakers.

U.S. Pat. No. 5,870,484, to Greenberger, shows a sound reproduction system in which both signals of a stereo pair of signals are radiated with a directional radiation pattern having a first order gradient characteristic over the frequency range where interaural time difference cues dominate localization in the human auditory system. The directional radiation patterns have main radiation lobes pointing in different directions.

U.S. Pat. No. 5,809,150, to Eberbach, teaches a generalized method of providing direct and reflected sound energy in an enclosed listening space by varying several elements, including the low pass filter with delay, the angular position of each of the drivers, and the loudspeaker cabinet structure, as well as the directivity of the individual drivers.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention solves the above-described problems by providing the esthetic advantages of a ceiling-mounted speaker system and a solution to location displacement. By using directional-radiating devices aimed at suitable surfaces in the room, the sound appears to come from a height that matches the screen location. Also, with pattern control of the sound radiation, the sound clarity is enhanced as compared to traditional ceiling-mounted systems.

The novel features characteristic of the invention, as to organization and method of operation, together with further objects and advantages thereof, will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a bottom diagrammatic view showing an electro-acoustic transducer that comprises the core of the present invention;

FIG. 2 is a diagrammatic view showing the radiation pattern produced by the electro-acoustic transducer array of FIG. 1 when the drive units are fed identical signals;

FIG. 3 is a diagrammatic view showing the radiation pattern produced by the electro-acoustic transducer array of FIG. 1 when the drive units are fed signals of varying delay;

FIG. 4 is a block diagrammatic view showing an adjustable array unit with selective directionality adjustment means;

FIG. 5 is a diagrammatic view showing the apparent sound source of sound produced by a ceiling mounted electro-acoustic transducer unit that is an implementation of the present invention;

FIG. 6 is a diagrammatic view showing the apparent sound source produced by a multi-channel implementation of the inventive ceiling mounted loudspeaker system; and

FIG. 7 is a diagrammatic view showing the apparent sound source produced by a ceiling mounted single array electro-acoustic transducer unit according to the present invention.

### DETAILED DESCRIPTION OF THE INVENTION

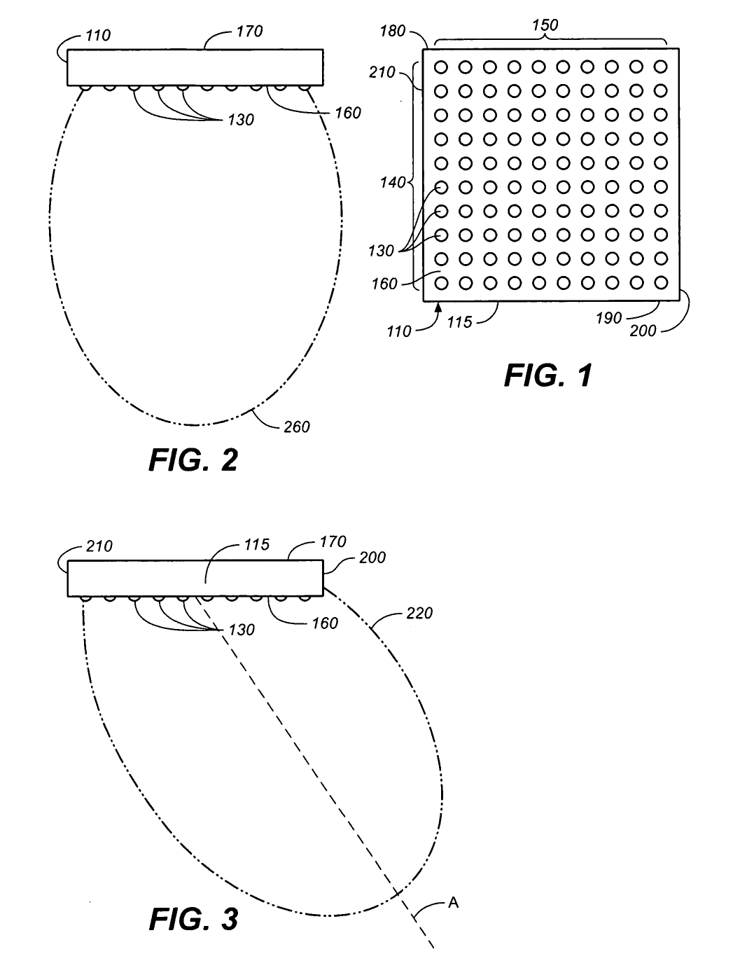

Referring to FIGS. 1 through 7, wherein like reference numerals refer to like components in the various views, there is illustrated therein a new and improved ceiling mounted audio loudspeaker system, generally denominated 100 herein.

FIG. 1 illustrates the essential functional component comprising the present invention. At the core of the invention is an electro-acoustic transducer 110 that aims sound waves to specific locations. This can be achieved through several means, including waveguides, planar radiators, horns, arrays of driver units, and several others. The first preferred embodiment 110 for the electro-acoustic transducer of the present invention comprises an array 120 of driver units 130, preferably arranged in rows and columns, 140, 150, with adjustable time and frequency domain characteristics (see FIG. 1). The loudspeaker cabinet 115 in which the driver unit array is disposed includes a bottom side 160, a top side 170, a front end 180, a rear end 190, a right side 200, and a left side 210.

Referring now to FIG. 2, when all the drive units are fed the same signal, the radiation lobe 160 is substantially perpendicular to the array and is largely focused and constrained to the area directly in front of the array. At low frequencies the radiation pattern will widen, depending on the dimensions of the array.

As shown in FIG. 3, when the drive units 130 are fed signals of varying time delay, incrementing in columns 150 from one side to the other, the sound radiation lobe will diverge away from the perpendicular (in the illustration, from the left side 210 to the right side 200). The main radiation axis will depend on the amount of delay applied across the array. This view is a front end view showing a radiation pattern produced by an exemplary 10′×10′ planar array transducer system in which the drive units are selectively delayed—the columns of left side drive units having no delay. Delay increases towards the right, and therefore the right units are the most delayed. The lobe produced 220 is therefore deflected at an angle to the right side. When this radiation pattern is produced, some amount of level and time domain correction may be needed to maintain lobing smoothness.

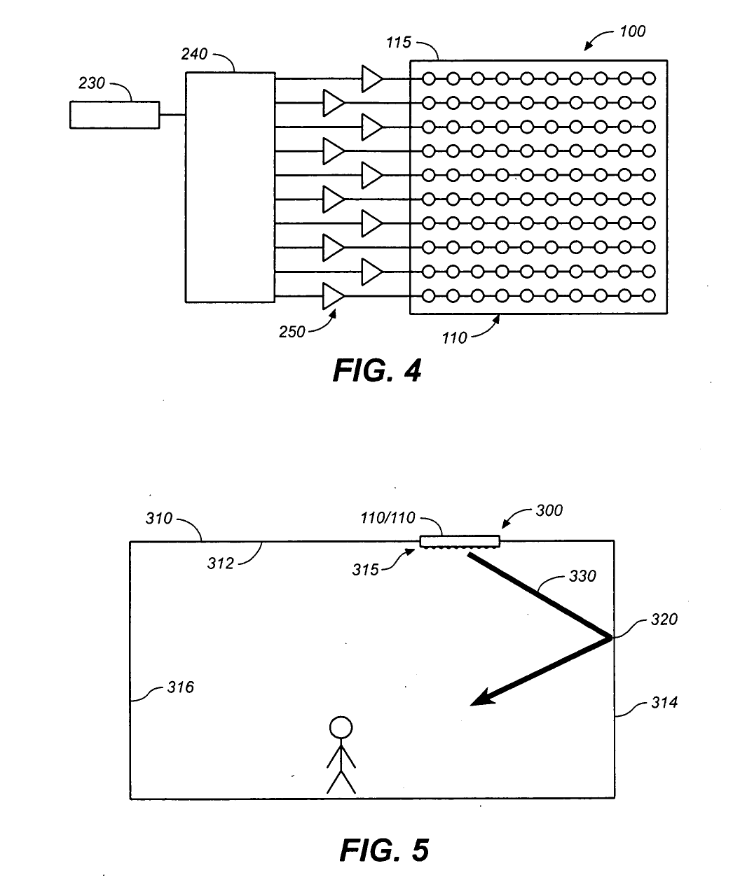

Referring now to FIG. 4, a block diagrammatic view showing an adjustable array unit, the complete array system 100 is shown to consist of an input circuit 230, a signal processing section 240, an array of power amplifiers 250, an array of electro-acoustic transducers 110, and an enclosure or loudspeaker cabinet 115 onto which the transducers are disposed in a generally planar relationship. Directionality in this unit is adjusted on one axis only. Directionality in the other axis remains perpendicular to the array axis. Two dimensional directivity control requires individual drive of each transducer.

The transducers are typically small devices, between 1 and 2 inches (2.54-5.08 cm) in diameter, and may have limited low frequency output capability. The system can be amended with one or more larger transducer units, typically 6 or 8 inches (15.24-20.32 cm) in diameter, fed signals by separate amplification devices.

In a playback environment, the inventive system may be laid out in a variety of ways in a room 310 having a ceiling 312, a front wall 314, side walls (not shown), and a rear wall 316. For a two-channel audio system 300, partially shown diagrammatically in a side view in FIG. 5, two array devices 110/110 are flush mounted on the ceiling 310 at the appropriate location to create a reflection off the wall. Although the transducers are positioned on the ceiling, the apparent sound sources 320 for the Left and Right channels are at the wall location where the sound beams 330 are aimed. The signal processing circuit is adjusted for appropriate location of the sound source. Alternatively a single centrally located transducer array can be used with two source signals that are steered in two directions so that the apparent location of each of the Left and Right channels is from the wall.

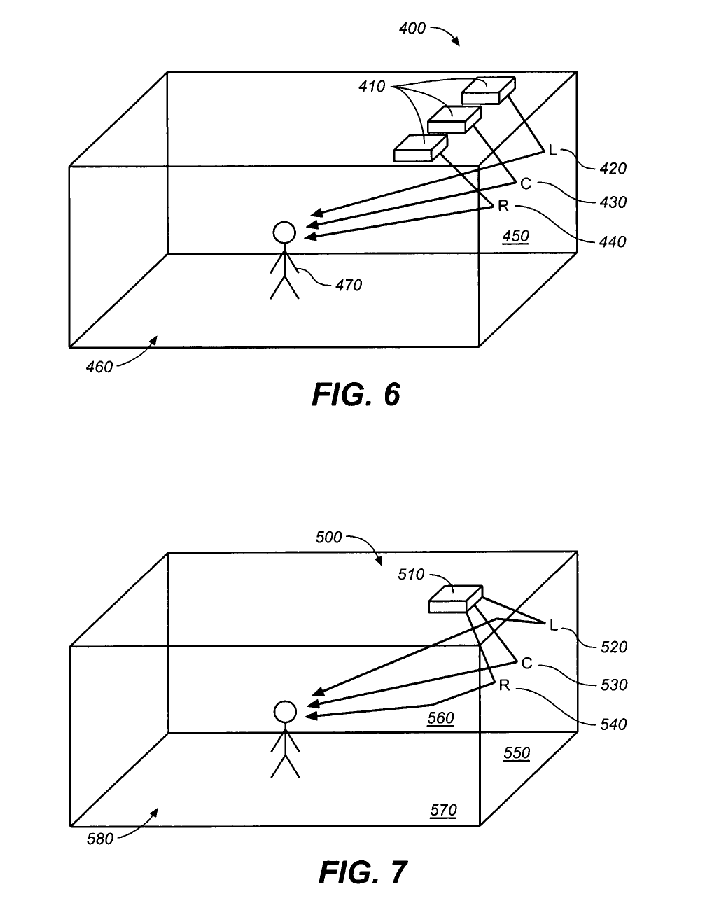

Referring now to FIG. 6, for a multi-channel surround-sound system 400, three electro-acoustic transducer array devices 410 can be used for the front channels, and a plurality of array devices can be used for the surround channels. Left/Center/Right sounds 420, 430, 440 reflected off the front wall 450 of a multi-channel audio Home Theater 460. The transducers are ceiling mounted and are adjusted for sound beams aimed along an oblique. Although the transducer devices are located on the ceiling, to the listener 470 the sound sources appear to come from the front wall. More transducer arrays can be located along the rear portion of the room to carry the surround channel signals. Two surround arrays will suffice for “5.1” channel systems and three arrays suffice for “5.1 EX” channel systems.

Alternatively, and now referring to FIG. 7, a single array system 500 can reproduce all of the sound channels with one centrally located electro-acoustic array transducer 510 fed with the source signals, and programmed to beam the multiple channels along different axes. In such a configuration, Left/Center/Right sounds 520, 530, 540, are generated by a single array device and are reflected off the front wall 550, left wall 560, and right wall 570 of a multi-channel audio Home Theater 580. The transducer is ceiling mounted and is adjusted for sound beams aimed along three oblique axes. Again, although the transducer device is positioned on the ceiling, to the listener the sound sources appear to come from the front wall. The wall section may need an angled reflector for best results.

It will be appreciated that more channels of sound can be fed to the transducer and beamed along other axes of the room to simulate the surround channel effects. Each axis in this alternative embodiment of the inventive system is adjusted so as to reflect off a wall at the appropriate location to simulate a physical loudspeaker location. In a very simplified scheme, all the multi-channel sources are fed to one centrally located ceiling-mounted array device, and the various beams are directed so as to appear to emanate from the proper wall direction.

Using any of the above-described preferred embodiments of the inventive ceiling mounted loudspeaker system, a complete multi-channel home theater sound system can be installed flush to the ceiling and generate a sound field that appears to emanate from the walls around the listener. This sound field simulates the effect of having multiple speakers positioned on stands or on walls, without compromising any of the aesthetic elements of the home theater environment. The sound system consists of a single or a plurality of directional electro-acoustic devices. Each device produces a beam that is aimed towards an appropriate wall. The sound along the direct field of each device to the listener is very low in level. The sound therefore heard by the listener as coming from the walls.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A ceiling mounted loudspeaker system, comprising:
a room having a ceiling, a front wall, and side walls;
at least one electro-acoustic transducer unit for generating a radiation pattern of sound waves directed to specific locations, said transducer unit mounted in said ceiling.

2. The system of claim 1, wherein said transducer unit comprises an input circuit, a signal processing section, an array of power amplifiers, a loudspeaker cabinet, and an audio signal transducer array disposed in said cabinet.

3. The system of claim 2, wherein said transducer unit comprises an array of electro-acoustic driver units disposed in a generally planar relationship in said cabinet.

4. The system of claim 3, wherein sound wave directionality produced by said transducer unit is adjusted on one axis of said array while directionality in the other axis of said array remains perpendicular to plane in which said driver units are disposed.

5. The system of claim 1, wherein said at least one electro-acoustic transducer unit is selected from the group consisting of waveguide, planar radiator, horn, and driver unit array.

6. The system of claim 5, wherein said transducer unit is an array of driver units arranged in a grid of rows and columns and disposed in a substantially planar relationship in a loudspeaker cabinet.

7. The system of claim 6, wherein said driver units include adjustable time and frequency domain characteristics.

8. The system of claim 6, wherein said loudspeaker cabinet is a box including a bottom side, a top side, a front end, a rear end, a right side, and a left side,

9. The system of claim 5, wherein when all of said driver units in said array are fed the same signal, the radiation lobe produced is substantially perpendicular to said front of said array and is largely focused and constrained to the area directly in front of said array.

10. The system of claim 5, wherein when said driver units are fed signals of varying delay, incrementing in said columns from one side to the other side of said array, the sound radiation lobe produced will diverge away from a line perpendicular said front side of said cabinet.

11. A method of improving the sound field pattern in an audio/visual media room having a ceiling, a front wall, side walls, and a rear wall, said method comprising the steps of:
providing at least one electro-acoustic transducer unit having an input circuit, a signal processing section, an array of power amplifiers, a loudspeaker cabinet, and a plurality driver units disposed in a substantially planar array in the cabinet;
mounting each transducer unit on the ceiling of the room at a location that creates a reflection off the front wall; and
adjusting the signal processing circuit in the transducer unit to optimally position the perceived sound source.

12. The method of claim 11, further including the step of centrally locating a single transducer unit and providing left and right source signals;
steering the left and right source signals so that the apparent location of each of the Left and Right channels is from a corresponding side wall.

13. The method of claim 12, further including the steps of:
providing three electro-acoustic transducer units for the front channels;
providing a plurality of array devices for surround channels, such that Left/Center/Right sounds are reflected off the front wall of the audio-visual room; and
adjusting the transducer units to aim sound beams along an oblique.

14. A method of improving the sound field in a home theater room having a ceiling, front wall, side walls, and rear wall, said method comprising the steps of:
providing an electro-acoustic transducer unit having a single array of drivers arranged in a grid of rows and columns;
mounting the transducer unit in the ceiling;
feeding signals from multiple channels to the transducer unit;
programming the transducer unit to beam Left/Center/Right channels along different axes toward the front wall of the room, such the sound sources are perceived by a listener in the room to be coming from the front wall.

15. The method of claim 14, further including the steps of installing an angled sound reflector on the front wall to enhance sound reflection of sounds generated by the ceiling mounted transducer unit.
